(19) United States
(12) Patent Application Publication
(10) Pub. No.: US 2022/0026295 A1
(43) Pub. Date: Jan. 27, 2022

(54) DETECTION DEVICE

(71) Applicant: SONY GROUP CORPORATION, TOKYO (JP)

(72) Inventors: TAKASHI KITO, TOKYO (JP); YASUHISA KAMIKAWA, TOKYO (JP); KAZUHITO WAKANA, TOKYO (JP)

(21) Appl. No.: 17/296,717

(22) PCT Filed: Sep. 11, 2019
(86) PCT No.: PCT/JP2019/035667

§ 371 Date: May 25, 2021

(30) Foreign Application Priority Data
Dec. 4, 2018 (JP) 2018-227097

(51) Int. Cl. G01L 5/16; G01B 11/00

(52) U.S. Cl. CPC G01L 5/16; G01B 11/00

(57) ABSTRACT

An environmental contact unit 20 is formed into a hemispherical shell shape, and a contact surface with an environmental surface (for example, a floor surface, a wall surface and the like) is formed into a spherical shape. A support unit 30 supports the environmental contact unit 20 so as to be movable around a first axis and around a second axis orthogonal to the first axis. Ranging sensors 41x and 41y are provided with an angular difference of 90 degrees around a third axis orthogonal to the first axis and the second axis in an opposing position between an end face 211 of the environmental contact unit 20 and an opposing surface 341 provided on the support unit 30 so as to be opposed to the end face 211. An elastic body 51 is included between the end face 211 of the environmental contact unit and the opposing surface 341 of the support unit 30, and the ranging sensors 41x and 41y may measure displacement of the environmental contact unit with respect to the support unit generated in response to a force applied to a contact point between the environmental surface and the contact surface of the environmental contact unit, that is, a change in interval between the end face 211 and the opposing surface 341, and calculate a tangential force on the basis of a measurement result. It becomes possible to detect the tangential force with a robust and simple configuration.

### TECHNICAL FIELD

This technology relates to a detection device capable of detecting a tangential force with a robust and simple configuration.

### BACKGROUND ART

Conventionally, a sensor that detects a tangential force detects a moment force. For example, in Patent Document 1, at least three or more measuring beams extending radially in a radial direction from a central shaft to which a load action unit subjected to a force action is coaxially connected, at least three or more supporting beams arranged at intervals on a load action unit side in an axial direction of the central shaft and extend radially in the radial direction from the central shaft, and a connection unit that connects ends of the measuring beams and the supporting beams are provided, and deformation of the measuring beams due to the force acting on the load action unit is detected by a deformation detection sensor.

### CITATION LIST

### Patent Document

### Patent Document 1: Japanese Patent Application Laid-Open No. 2017-058337

### SUMMARY OF THE INVENTION

### Problems to be Solved by the Invention

By the way, in a case where a moment force is detected by a displacement sensor, the sensor tends to be fragile to a bending moment load, and this structurally lacks strength in a bending direction applied to a strain body for being used in a part where a strong bending moment acts. Furthermore, a force sensor disclosed in Patent Document 1 has a complicated structure for ensuring sufficient rigidity against the moment.

Therefore, an object of this technology is to provide a detection device capable of detecting a tangential force with a robust and simple configuration.

### Solutions to Problems

A first aspect of this technology is a detection device provided with:

an environmental contact unit a contact surface of which is formed into a spherical shape;

a support unit that supports the environmental contact unit so as to be movable around a first axis and around a second axis orthogonal to the first axis; and

a displacement measurement unit that measures displacement of the environmental contact unit with respect to the support unit generated in response to a force applied to a contact point between an environmental surface and the contact surface of the environmental contact unit.

In this technology, the environmental contact unit the contact surface of which is formed into the spherical shape and the support unit that supports the environmental contact unit so as to be movable around the first axis and around the second axis orthogonal to the first axis are connected to each other by a movable joint structure, which is a ball joint structure or a gimbal structure. A plurality of displacement measurement units is provided with a predetermined angular difference of, for example, 90 degrees, or three displacement measurement units are provided with an angular difference of 120 degrees around a third axis orthogonal to the first axis and the second axis, for example. The environmental contact unit is formed into a hemispherical shell shape, and the displacement measurement unit is provided in an opposing position between an end face of the environmental contact unit and an opposing surface provided on the support unit so as to be opposed to the end face. The displacement measurement unit measures the displacement of the environmental contact unit with respect to the support unit generated in response to the force applied to the contact point between the environmental surface and the contact surface of the environmental contact unit. For example, an elastic body is included between the end face of the environmental contact unit and the opposing surface of the support unit, and the displacement measurement unit measures an interval between the end face of the environmental contact unit and the opposing surface of the support unit. Furthermore, the displacement measurement unit may measure a pressure between the end face of the environmental contact unit and the opposing surface of the support unit generated by the displacement of the environmental contact unit with respect to the support unit.

Furthermore, the displacement measurement unit may use an image sensor that obtains a two-dimensional captured image. In this case, a reference subject serving as a reference of a position is provided on the environmental contact unit, and the image sensor is provided on the support unit so as to include the reference subject of the environmental contact unit in an imaging range. The displacement measurement unit measures a change in position of the reference subject in the captured image generated by the displacement of the environmental contact unit with respect to the support unit.

The contact surface of the environmental contact unit may be formed by using an elastomer. Furthermore, the support unit may be provided with an elastic portion in which elastic bodies of different elastic coefficients are connected in series, and a linear motion shaft fixed to a connection point of the elastic bodies in the elastic portion and held so as to be movable in an expansion/contraction direction of the elastic bodies. In this case, a moving direction of the linear motion shaft is a direction of a third axis orthogonal to the first axis and the second axis, and the displacement measurement unit measures a movement amount of the linear motion shaft. Moreover, an arithmetic unit that calculates a force applied to the contact point on the basis of a measurement result of the displacement measurement unit may further be provided.

### BRIEF DESCRIPTION OF DRAWINGS

FIG. 1 is a view illustrating a configuration of a first embodiment.

FIG. 2 is a view illustrating a coordinate system of a detection device.

FIG. 3 is a view illustrating a case where the detection device is tilted.

FIG. 4 is a view for explaining calculation of a tangential force.

FIG. 5 is a view illustrating a configuration of a second embodiment.

FIG. 6 is a view illustrating a captured image generated by an image sensor.

FIG. 7 is a view illustrating arrangement of ranging sensors in a configuration of a third embodiment.

FIG. 8 is a view illustrating a configuration of a force detection unit.

FIG. 9 is a view illustrating a case where the present technology is applied to a leg of a robot.

### MODE FOR CARRYING OUT THE INVENTION

Hereinafter, a mode for carrying out the present technology is described. Note that the description is given in the following order.

1. First Embodiment

2. Second Embodiment

3. Third Embodiment

4. Other Embodiment

5. Application Example

### 1. First Embodiment

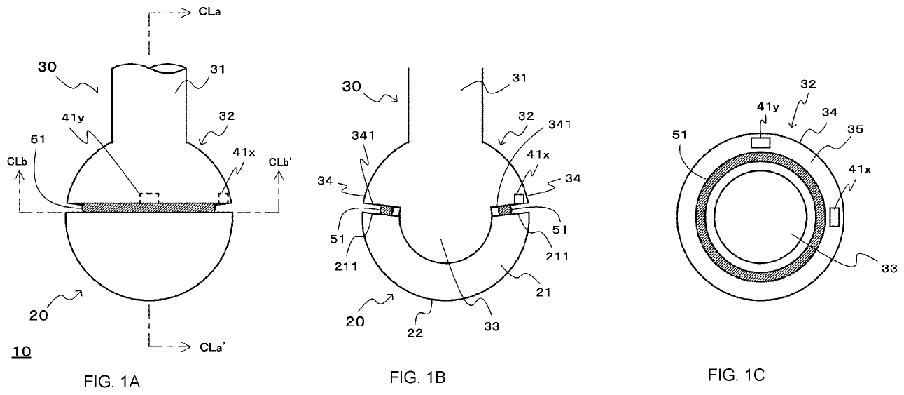

FIG. 1 illustrates a configuration of a first embodiment of the present technology. Note that (a) of FIG. 1 illustrates an external appearance of a detection device 10, (b) of FIG. 1 is a schematic cross-sectional view taken along CLa-CLa′ in (a) of FIG. 1, and (c) of FIG. 1 is a schematic cross-sectional view taken along CLb-CLb′ in (a) of FIG. 1.

The detection device 10 includes an environmental contact unit 20, a support unit 30, and a displacement measurement unit 40.

The environmental contact unit 20 and the support unit 30 are connected to each other by a movable joint structure, for example, a ball joint structure. The support unit 30 includes a support column 31 and a connection unit 32 at a tip end of the support column 31. The connection unit 32 includes a spherical portion 33 protruding in an axial direction of the support column 31 and a regulation unit 34 protruding in a radial direction from the spherical portion 33.

The environmental contact unit 20 is formed into a hemispherical shell shape, and an outer surface of a main body 21 having a hemispherical shell shape is provided with a contact surface 22 brought into contact with an environmental surface (for example, a floor surface, a wall surface and the like), and the contact surface 22 has a curved shape protruding in a direction toward the environmental surface. An inner surface of the main body 21 fits to the spherical portion 33 of the support unit 30 and is configured so that the environmental contact unit 20 is movable along a spherical surface of the spherical portion 33. Furthermore, the environmental contact unit 20 is formed so that, in a state in which this is fitted to the spherical portion 33 of the support unit 30, an end face 211 of the main body 21 is opposed to an end face 341 of the regulation unit 34 (also referred to as an opposing surface 341 of the support unit 30) provided on the support unit 30.

The environmental contact unit 20 or the contact surface 22 of the environmental contact unit 20 is formed by using, for example, an elastomer so that characteristics such as hardness, frictional force, and durability may be adjusted at the time of manufacture according to the environmental surface supposed to be brought into contact with the same. Moreover, the environmental contact unit 20 or the contact surface 22 of the environmental contact unit 20 is made replaceable when this is worn or damaged.

In a position in which the end face 211 of the environmental contact unit 20 and the opposing surface 341 of the support unit 30 are opposed to each other, a displacement measurement unit that measures displacement of the environmental contact unit 20 with respect to the support unit 30 generated in response to a force applied to a contact point between the environmental surface and the contact surface 22 of the environmental contact unit 20, for example, ranging sensors 41x and 41y are provided. Furthermore, for example, a ring-shaped elastic body 51 is provided between the end face 211 of the environmental contact unit 20 and the opposing surface 341 of the support unit 30. The ranging sensors 41x and 41y are one-dimensional ranging sensors (for example, infrared ranging sensors) a ranging direction of which is in the axial direction of the support column 31, and are provided with a predetermined angular difference, for example, 90 degrees as illustrated in FIG. 1 around the axis of the support column 31. The ranging sensors 41x and 41y measure a distance to the end face 211 of the environmental contact unit 20, that is, an interval between the end face 211 of the environmental contact unit 20 and the opposing surface 341 of the support unit 30, and generate detection information indicating a measurement result.

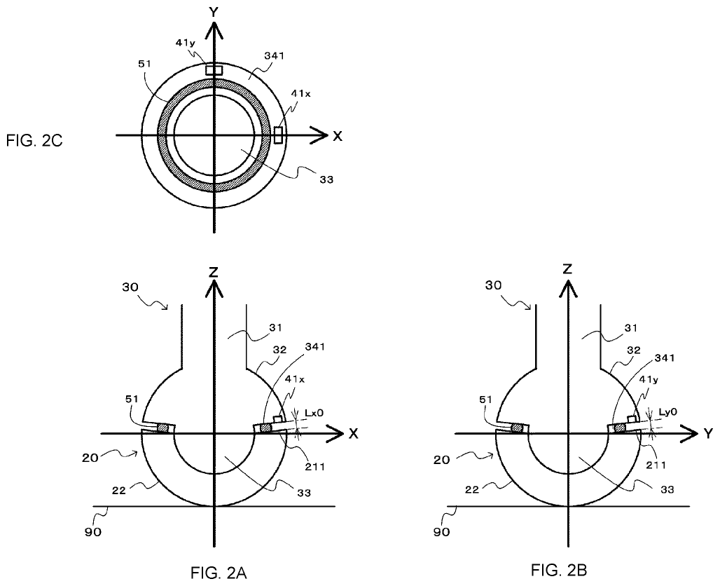

FIG. 2 illustrates a coordinate system of the detection device. In the detection device 10, in a direction of a plane on which the end face 211 of the environmental contact unit 20 and the opposing surface 341 of the support unit 30 are opposed to each other, one direction on a two-dimensional plane centered on the spherical portion 33 of the support unit 30 is set to an X axis direction, and a direction orthogonal to the X axis is set to a Y axis direction. Furthermore, a vertical direction with respect to the two-dimensional plane including the X axis and the Y axis passing through the center of the spherical portion of the support unit 30, that is, the axial direction of the support column 31 is set to a Z axis direction. Note that, when the vertical direction with respect to the environmental surface 90 with which the environmental contact unit 20 is brought into contact and the Z axis direction of the detection device 10 coincide with each other, an interval measured by the ranging sensor 41x is set to an interval Lx0, and an interval measured by the ranging sensor 41y is set to an interval Ly0.

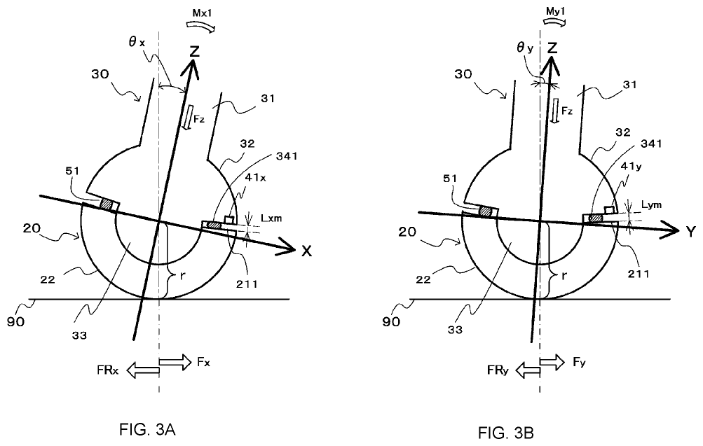

FIG. 3 illustrates a case where the detection device is tilted. Note that FIG. 3 illustrates a case where the Z axis is tilted at an angle θx in an X direction and at an angle θy in a Y direction with respect to the vertical direction of the environmental surface 90.

Suppose that the interval measured by the ranging sensor 41x changes, for example, from the interval Lx0 to an interval Lxm because the Z axis is tilted at the angle θx in the X direction with respect to the vertical direction of the environmental surface 90. Furthermore, suppose that the interval measured by the ranging sensor 41y changes, for example, from the interval Ly0 to an interval Lym because the Z axis is tilted at the angle θy in the Y direction with respect to the vertical direction of the environmental surface 90.

Here, a distance from a contact point U between the environmental surface 90 and the environmental contact unit 20 to the center of the spherical portion 33 of the support unit 30 is set to a distance r, an elastic coefficient in a position of the ranging sensor 41x of the elastic body 51 is set to “Kx”, and an elastic coefficient in a position of the ranging sensor 41y thereof is set to “Ky”.

In this case, a force Fx applied in an x direction of the environmental surface 90 at the contact point U may be calculated on the basis of expression (1). Note that, in expression (1), displacement dx is calculated on the basis of expression (2). Furthermore, a force Fy applied in a y direction of the environmental surface 90 at the contact point U may be calculated on the basis of expression (3). Note that, in expression (3), displacement dy is calculated on the basis of expression (4).

Fx=Kx×dx (1)

dx=Lx0−Lxm (2)

Fy=Ky×dy (3)

dy=Ly0−Lym (4)

Furthermore, a rotational moment Mx around the X axis illustrated in FIG. 3 may be calculated on the basis of expression (5), and a rotational moment My around the Y axis may be calculated on the basis of expression (6). Note that, in FIG. 3, forces FRx and FRy indicate forces acting on the environmental surface 90.

Mx=Fy×r (5)

My=Fx×r (6)

In this manner, when the elastic coefficients Kx and Ky are stored in advance and the ranging sensors 41x and 41y are provided around the axis of the support column 31 (around the Z axis) with a phase difference of 90 degrees, it is possible to calculate a tangential force having a two-dimensional direction on the basis of the measurement results of the ranging sensors 41x and 41y and the elastic coefficients stored in advance.

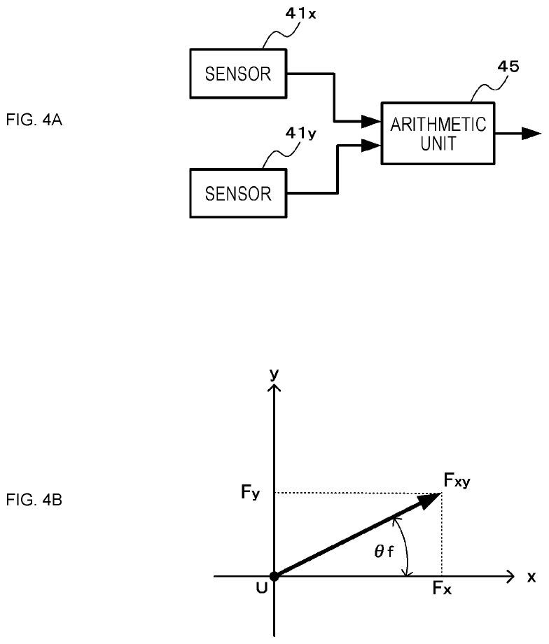

FIG. 4 is a view for illustrating the calculation of the tangential force. For example, an arithmetic unit 45 illustrated in (a) of FIG. 4 is allowed to store the elastic coefficients Kx and Ky in advance. The arithmetic unit 45 performs arithmetic operations of expressions (1) to (4) described above using the measurement results obtained by the ranging sensors 41x and 41y, and calculates the forces Fx and Fy applied in the x direction and the y direction, respectively, of the environmental surface 90 at the contact point U. Moreover, the arithmetic unit 45 calculates a tangential force Fxy applied to the contact point U and a direction θf of the tangential force Fxy as illustrated in FIG. 4 (b) on the basis of expressions (7) and (8). Furthermore, the arithmetic unit 45 may calculate the rotational moments Mx and My by performing arithmetic operations of expressions (5) and (6). Note that the arithmetic unit 45 may be provided on the detection device 10 or on a moving body that uses the detection device 10.

$$\begin{matrix}[ Mathematical Expression 1 ] & \\ {F}_{x y} = \sqrt{{F}_{x}^{2} + {F}_{y}^{2}} & ( 7 ) \\ {θ}_{f} = {tan}^{- 1} ( \frac{{F}_{y}}{{F}_{x}} ) & ( 8 )\end{matrix}$$

In this manner, according to the first embodiment, it becomes possible to detect the magnitude and direction of the tangential force at the contact point between the environmental contact unit 20 arranged at a tip end of the support unit 30 and the environmental surface 90, and the magnitude and direction of the rotational moment acting around the environmental contact unit 20. Furthermore, the detection device 10 may detect a moment acting on the contact point between the environmental contact unit 20 and the environmental surface 90 by displacement of the elastic body 51 according to a moment force. Therefore, the structure may be made simpler than that of a conventional detection device that measures a rotational moment acting on a beam with a strain gauge, for example. Furthermore, a general force sensor tends to be fragile to a bending moment load, and this has a disadvantage that strength in a bending direction applied to a strain body is structurally insufficient to be used in a part where a strong bending moment acts. However, in the present technology, since the displacement in a compression direction is measured by the ranging sensor without using the strain body of the beam structure, sufficient strength may be easily secured as compared with the conventional technology.

Furthermore, since a measurable tangential force may be switched by changing the elastic coefficient of the elastic body 51, it is possible to easily adjust a measurement range of the tangential force without significantly changing the structure of the detection device.

Moreover, in a situation in which the environmental contact unit 20 slides on the surface of the environmental surface 90, it becomes possible to detect the frictional force acting on the contact point between the environmental contact unit 20 and the environmental surface 90 and the direction thereof on the basis of the detection information of the displacement of the environmental contact unit 20 with respect to the support unit 30 even when the contact point changes over time.

### 2. Second Embodiment

Next, a second embodiment is described. In the second embodiment, displacement of an environmental contact unit with respect to a support unit is detected by using an image sensor. Specifically, the image sensor is provided on either the support unit or the environmental contact unit, and a reference subject (for example, a fiducial mark such as a circle or a square) that serves as a reference of a position is provided on the other. The image sensor detects a change in position of the reference subject generated by the displacement of the environmental contact unit with respect to the support unit in an obtained captured image.

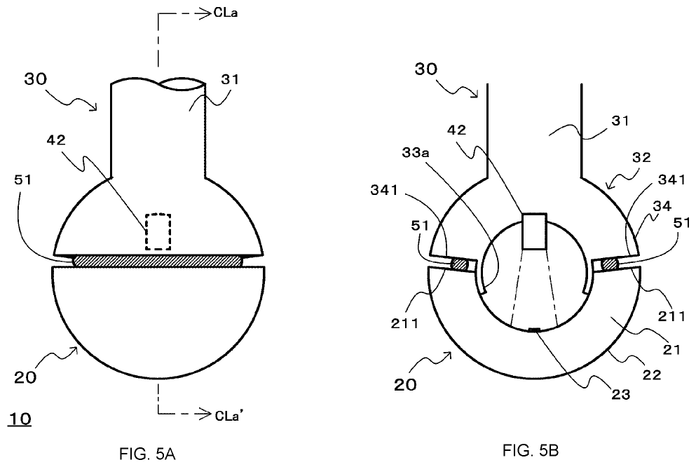

FIG. 5 illustrates a configuration of the second embodiment of the present technology. Note that (a) of FIG. 5 illustrates an external appearance of a detection device 10, and (b) of FIG. 5 is a schematic cross-sectional view taken along CLa-CLa′ in (a) of FIG. 5.

The detection device 10 includes an environmental contact unit 20, a support unit 30, and a displacement measurement unit 40 as in the first embodiment.

The environmental contact unit 20 and the support unit 30 are connected to each other by a ball joint structure, for example. The support unit 30 includes a support column 31 and a connection unit 32 at a tip end of the support column 31. The connection unit 32 includes a sliding portion 33a having a spherical shell shape protruding in an axial direction of the support column 31 formed thereon, and includes a regulation unit 34 protruding in a radial direction from the sliding portion 33a. The sliding portion 33a has a shape corresponding to an inner surface of a main body 21 of the environmental contact unit 20 described later. An image sensor 42 is provided inside the sliding portion 33a in a position opposed to the inner surface of the main body 21 in the environmental contact unit 20. Moreover, in the sliding portion 33a, at least an imaging range of the image sensor 42 is opened.

The environmental contact unit 20 is formed into a hemispherical shell shape, and an outer surface of a main body 21 having a hemispherical shell shape is provided with a contact surface 22 brought into contact with an environmental surface (for example, a floor surface, a wall surface and the like), and the contact surface 22 has a curved shape protruding in a direction toward the environmental surface. An inner surface of the main body 21 fits to the spherical portion 33 of the support unit 30 and is configured so that the environmental contact unit 20 is movable along a spherical surface of the spherical portion 33. Moreover, a reference subject 23 that serves as a reference of a position of the environmental contact unit 20 is provided on the inner surface of the main body 21, and this is imaged by the image sensor 42 provided on the support unit 30. Furthermore, the environmental contact unit 20 is formed so that, in a state in which this is fitted to the spherical portion 33 of the support unit 30, an end face 211 of the main body 21 is opposed to an opposing surface 341 of the support unit 30.

The environmental contact unit 20 or the contact surface 22 of the environmental contact unit 20 is formed by using, for example, an elastomer so that characteristics such as hardness, frictional force, and durability may be adjusted at the time of manufacture according to the environmental surface supposed to be brought into contact with the same. Moreover, the environmental contact unit 20 or the contact surface 22 of the environmental contact unit 20 is made replaceable when this is worn or damaged.

For example, a ring-shaped elastic body 51 is provided between the end face 211 of the environmental contact unit 20 and the opposing surface 341 of the support unit 30.

The image sensor 42 being the displacement measurement unit generates an image signal of a captured image obtained by imaging the inner surface of the main body 21 of the environmental contact unit 20.

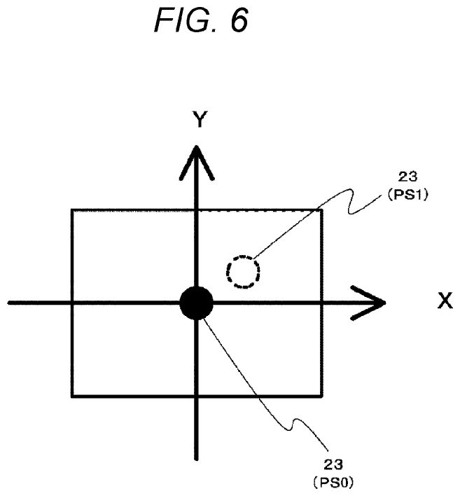

FIG. 6 illustrates the captured image generated by the image sensor. Here, in a case where a coordinate system of the detection device is set as illustrated in FIG. 2, in a case where, for example, a horizontal direction of the captured image is an X axis direction, a perpendicular direction of the captured image is a Y axis direction. Furthermore, in a case where an optical axis direction of the image sensor 42 is a Z axis direction, the center position of the captured image is an intersection of the X axis direction and the Y axis direction. Moreover, the reference subject 23 is provided so as to be in the center position (intersection of the X axis and the Y axis) of the captured image in a case where the Z axis direction of the detection device 10 and a vertical direction of an environmental surface 90 coincide with each other.

Here, in a state in which the environmental contact unit 20 of the detection device 10 is in contact with the environmental surface 90, when the Z axis direction of the detection device 10 is tilted with respect to the vertical direction of the environmental surface 90 and the environmental contact unit 20 is displaced with respect to the support unit 30, a position of the reference subject 23 in the captured image changes according to the displacement of the environmental contact unit 20 with respect to the support unit 30. For example, in FIG. 6, a position of the reference subject 23 changes from a position PS0 to a position PS1.

Therefore, by detecting in advance a relationship between a position in a horizontal direction of the reference subject 23 and a force Fx on the basis of the force Fx applied in an x direction at a contact point U between the environmental contact unit 20 and the environmental surface 90 and an elastic coefficient Kx, and a relationship between a position in a perpendicular direction of the reference subject 23 and a force Fy on the basis of the force Fy applied in a y direction at the contact point U and an elastic coefficient Ky, the forces Fx and Fy become clear from the position after the change of the reference subject 23. That is, it becomes possible to detect a tangential force Fxy and a direction θf of the tangential force also by using the image sensor 42.

In this manner, according to the second embodiment, it becomes possible to detect the magnitude and direction of the tangential force at the contact point between the environmental contact unit 20 arranged at the tip end of the support unit 30 and the environmental surface 90, and the magnitude and direction of the rotational moment acting around the environmental contact unit 20 on the basis of the displacement in the two-dimensional direction of the reference subject 23 in the captured image obtained by the image sensor 42. Furthermore, in the second embodiment, as in the first embodiment, a moment acting on the contact point between the environmental contact unit 20 and the environmental surface 90 may be detected by displacement of the elastic body 51 according to a moment force, so that it becomes possible to provide the detection device capable of detecting the tangential force with a robust and simple configuration.

### 3. Third Embodiment

Next, in a third embodiment, a detection device capable of also detecting a force applied in a Z axis direction of a detection device is described. In the third embodiment, three ranging sensors according to the first embodiment are arranged with a predetermined angular difference, for example, an angular difference of 120 degrees, and not only forces in X axis and Y axis directions but also a force Fz in the Z axis direction illustrated in FIG. 3 are detected from measurement results of the respective ranging sensors.

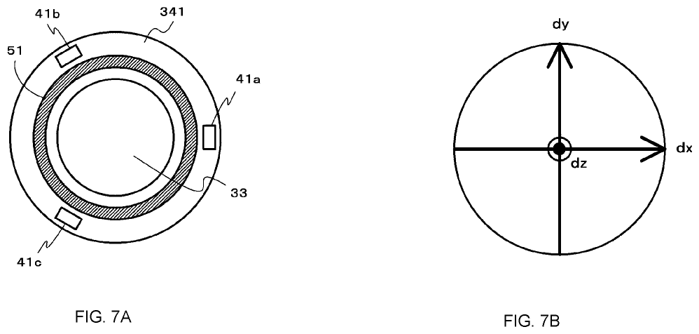

FIG. 7 illustrates arrangement of the ranging sensors in a configuration of the third embodiment of the present technology. As illustrated in (a) of FIG. 7, a detection device 10 is provided with ranging sensors 41b and 41c having an angular difference of 120 degrees with respect to a ranging sensor 41a.

Moreover, the displacement detected by the ranging sensors 41a, 41b, and 41c is converted into displacement in an orthogonal coordinate system. Here, for example, the ranging sensor 41a is provided in the X axis direction, and displacement detected by the ranging sensor 41a is set to displacement da, displacement detected by the ranging sensor 41b is set to displacement db, and displacement detected by the ranging sensor 41c is set to displacement dc. In this case, an arithmetic unit 45 performs an arithmetic operation of expression (9) for conversion to displacement dx in the X axis direction illustrated in (b) of FIG. 7. Furthermore, this performs an arithmetic operation of expression (10) for conversion to displacement dy in the Y axis direction illustrated in (b) of FIG. 7, and an arithmetic operation of expression (11) for conversion to displacement dz in the Z axis direction illustrated in (b) of FIG. 7.

$$\begin{matrix}[ Mathematical Expression 2 ] & \\ {d}_{x} = {d}_{1} - \frac{{d}_{2} + {d}_{3}}{2} & ( 9 ) \\ {d}_{y} = \frac{\sqrt{3}}{2} ( {d}_{2} - {d}_{3} ) & ( 10 ) \\ {d}_{z} = \frac{{d}_{1} + {d}_{2} + {d}_{3}}{3} & ( 11 )\end{matrix}$$

Moreover, in a case where an elastic coefficient of an elastic body 51 is equally “K” in any position, the arithmetic unit 45 calculates a force Fx applied in the X axis direction, a force Fy applied in the Y axis direction, and the force Fz applied in the Z axis direction at the contact point U between the environmental contact unit 20 and the environmental surface 90 on the basis of expressions (12) to (13).

Fx=K×dx (12)

Fy=K×dy (13)

Fz=K×dz (14)

In this manner, in the third embodiment, not only the forces Fx and Fy in a planar direction of the environmental surface 90 but also the force Fz in a vertical direction may be detected. Note that, in the third embodiment also, as in the first embodiment, a moment acting on the contact point between the environmental contact unit 20 and the environmental surface 90 may be detected by displacement of the elastic body 51 according to a moment force, it becomes possible to provide the detection device capable of detecting the tangential force with a robust and simple configuration.

### 4. Other Embodiments

By the way, although the case where the infrared ranging sensor or the image sensor is used as the displacement measurement unit is illustrated in the above-described embodiments, a capacitive displacement sensor, a laser displacement sensor or the like may also be used. Furthermore, although the case where the elastic body 51 is provided in the position in which the end face 211 of the environmental contact unit 20 and the opposing surface 341 of the support unit 30 are opposed to each other, and the displacement of the environmental contact unit 20 with respect to the support unit 30 is detected by the distance sensor and the like is illustrated in the above-described embodiments, it is also possible to provide a pressure sensor in a position in which the end face 211 of the environmental contact unit 20 and the opposing surface 341 of the support unit 30 are opposed to each other and detect a pressure as the displacement of the environmental contact unit 20 with respect to the support unit 30. In this case, it becomes possible to detect forces Fx and Fy applied in an X axis direction and a Y axis direction, respectively, by the pressure sensor without using the elastic body 51.

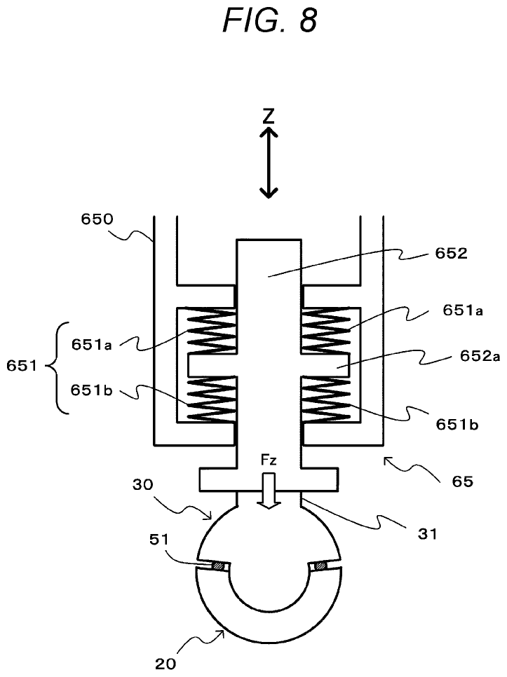

Furthermore, in a case where the force in the Z axis direction cannot be detected as in the case of the first embodiment or the second embodiment, the support unit 30 may be provided with a force detection unit that detects the force in the Z axis direction. FIG. 8 illustrates a configuration of the force detection unit. In a force detection unit 65, an elastic portion 651 is such that a spring 651a and a spring 651b having different spring constants are connected in series in the Z axis direction, for example. At a connection point between the spring 651a and the spring 651b, a force detection plate 652a of a linear motion shaft 652 movable in the Z axis direction is fixed. Note that the force detection plate 652a is formed so as to protrude in a direction orthogonal to an axial direction of the linear motion shaft 652. Ends of the springs 651a and 651b are fixed to a force detection unit housing 650 and the linear motion shaft 652 is fixed to a support column 31. If such force detection unit 65 is provided, a force Fz acting on the detection device 10 in the Z axis direction may be detected by displacement of the force detection plate 652a.

Moreover, although the case where the displacement measurement unit is provided on a support unit side is illustrated in the above-described embodiments, this may also be provided on the environmental contact unit. Furthermore, although the case where the environmental contact unit 20 and the support unit 30 are connected by the ball joint structure is illustrated in the above-described embodiments, the movable joint structure used for connecting the environmental contact unit 20 and the support unit 30 may have another structure, for example, a gimbal structure. In a case where the gimbal structure is used, if the displacement around the X axis and the displacement around the Y axis are detected by a sensor, it is possible to detect a tangential force Fxy and a direction θf of the tangential force Fxy at a contact point U as in the first embodiment and the second embodiment.

Note that the effect in the embodiments of the present specification is illustrative only; the effect is not limited thereto and there may also be an additional effect.

### 5. Application Example

According to such present technology, since tangential forces in an X axis direction and a Y axis direction of a detection device 10 may be detected at the same time, this may be used for motion control in a moving body. For example, in a case where the moving body is a robot, this may be used for measuring moments of fingertips, hip joints, ankle joints, shoulder joints and the like of the robot. Furthermore, this may also be used for measuring a friction vector of toes of a multi-legged robot, measuring a moment of a tip end of a medical robot forceps and the like.

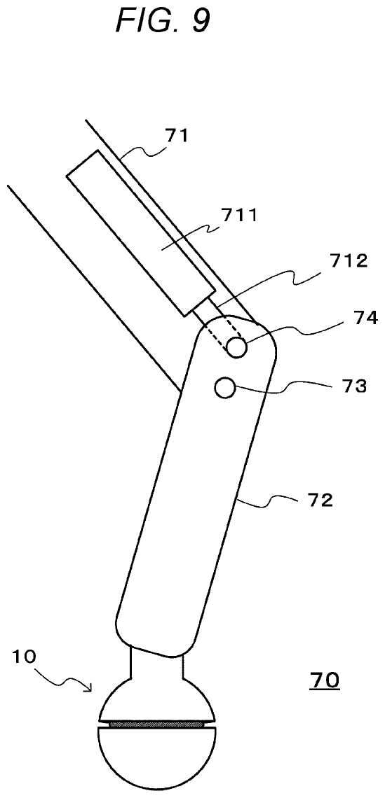

FIG. 9 illustrates a case where the present technology is applied to a leg of the robot. An upper leg 71 and a lower leg 72 of a leg 70 are connected to each other via a joint 73, and the detection device 10 of the present technology is provided on a lower end of the lower leg 72. The upper leg 71 is provided with an actuator (for example, series elastic actuator (SEA)) 711. The actuator 711 is fixed to the upper leg 71, and a linearly moving action unit 712 is connected to the lower leg 72 via a joint mechanism 74. Therefore, the series elastic actuator 711 may drive the lower leg 72 around the joint 73. Furthermore, the detection device 10 may detect a change in tangential force and the like when the lower leg 72 is driven by the series elastic actuator 711.

Note that the effect described in the present specification is illustrative only and is not limited; there may be an additional effect not described. Furthermore, the present technology should not be construed as being limited to the above-described embodiment of the technology. The embodiment of this technology discloses the present technology in the form of illustration, and it is obvious that those skilled in the art may modify or replace the embodiment without departing from the gist of the present technology. That is, in order to determine the gist of the present technology, claims should be taken into consideration.

Furthermore, the detection device of the present technology may also have the following configuration.

(1) A detection device provided with:

an environmental contact unit a contact surface of which is formed into a spherical shape;

a support unit that supports the environmental contact unit so as to be movable around a first axis and around a second axis orthogonal to the first axis; and

a displacement measurement unit that measures displacement of the environmental contact unit with respect to the support unit generated in response to a force applied to a contact point between an environmental surface and the contact surface of the environmental contact unit.

(2) The detection device according to (1), in which

a plurality of displacement measurement units is provided with a predetermined angular difference around a third axis orthogonal to the first axis and the second axis.

(3) The detection device according to (2), in which

the predetermined angular difference is set to 90 degrees.

(4) The detection device according to (2), in which

three displacement measurement units are provided with the predetermined angular difference set to 120 degrees.

(5) The detection device according to any one of (2) to (4), in which

the environmental contact unit is formed into a hemispherical shell shape, and

the displacement measurement unit is provided in an opposing position between an end face of the environmental contact unit and an opposing surface provided on the support unit so as to be opposed to the end face.

(6) The detection device according to (5), in which

an elastic body is included between the end face of the environmental contact unit and the opposing surface of the support unit, and

the displacement measurement unit measures an interval between the end face of the environmental contact unit and the opposing surface of the support unit as the displacement.

(7) The detection device according to (5), in which

the displacement measurement unit measures a pressure between the end face of the environmental contact unit and the opposing surface of the support unit generated by the displacement of the environmental contact unit with respect to the support unit.

(8) The detection device according to (1), in which

a reference subject that serves as a reference of a position is provided on the environmental contact unit,

an image sensor that obtains a two-dimensional captured image is provided on the support unit as the displacement measurement unit so as to include the reference subject of the environmental contact unit in an imaging range, and

the displacement measurement unit measures a change in position of the reference subject in the captured image generated by the displacement of the environmental contact unit with respect to the support unit.

(9) The detection device according to (8), in which

the environmental contact unit is formed into a hemispherical shell shape, and

an elastic body is included between an end face of the environmental contact unit and an opposing surface provided on the support unit so as to be opposed to the end face.

(10) The detection device according to (1), in which

the environmental contact unit and the support unit are connected to each other by a ball joint structure.

(11) The detection device according to (1), in which

the environmental contact unit and the support unit are connected to each other by a gimbal structure.

(12) The detection device according to any one of (1) to (11), in which

the environmental contact unit or the contact surface of the environmental contact unit is formed by using an elastomer.

(13) The detection device according to (1), in which

the support unit is provided with

an elastic portion in which elastic bodies of different elastic coefficients are connected in series, and

a linear motion shaft fixed to a connection point of the elastic bodies in the elastic portion and held so as to be movable in an expansion/contraction direction of the elastic bodies,

a moving direction of the linear motion shaft is a direction of a third axis orthogonal to the first axis and the second axis, and

the displacement measurement unit measures a movement amount of the linear motion shaft.

(14) The detection device according to any one of (1) to (13), further provided with:

an arithmetic unit that calculates a force applied to the contact point on the basis of a measurement result of the displacement measurement unit.

### REFERENCE SIGNS LIST

10 Detection device
20 Environmental contact unit
21 Main body
22 Contact surface
23 Reference subject
30 Support unit
31 Support column
32 Connection unit
33 Spherical portion
33a Sliding portion
34 Regulation unit
40 Displacement measurement unit
41a, 41b, 41c, 41x, 41y Ranging sensor
42 Image sensor
45 Arithmetic unit
51 Elastic body
65 Force detection unit
70 Leg
71 Upper leg
72 Lower leg
73 Joint
74 Joint mechanism
211 End face
341 Opposing surface (end face)
650 Force detection unit housing
651 Elastic portion
651a, 651b Spring
652 Linear motion shaft
652a Force detection plate
711 Actuator (series elastic actuator)
712 Action unit

1. A detection device comprising:
an environmental contact unit a contact surface of which is formed into a spherical shape;
a support unit that supports the environmental contact unit so as to be movable around a first axis and around a second axis orthogonal to the first axis; and
a displacement measurement unit that measures displacement of the environmental contact unit with respect to the support unit generated in response to a force applied to a contact point between an environmental surface and the contact surface of the environmental contact unit.

2. The detection device according to claim 1, wherein
a plurality of displacement measurement units is provided with a predetermined angular difference around a third axis orthogonal to the first axis and the second axis.

3. The detection device according to claim 2, wherein
the predetermined angular difference is set to 90 degrees.

4. The detection device according to claim 2, wherein
three displacement measurement units are provided with the predetermined angular difference set to 120 degrees.

5. The detection device according to claim 2, wherein
the environmental contact unit is formed into a hemispherical shell shape, and
the displacement measurement unit is provided in an opposing position between an end face of the environmental contact unit and an opposing surface provided on the support unit so as to be opposed to the end face.

6. The detection device according to claim 5, wherein
an elastic body is included between the end face of the environmental contact unit and the opposing surface of the support unit, and
the displacement measurement unit measures an interval between the end face of the environmental contact unit and the opposing surface of the support unit as the displacement.

7. The detection device according to claim 5, wherein
the displacement measurement unit measures a pressure between the end face of the environmental contact unit and the opposing surface of the support unit generated by the displacement of the environmental contact unit with respect to the support unit.

8. The detection device according to claim 1, wherein
a reference subject that serves as a reference of a position is provided on the environmental contact unit,
an image sensor that obtains a two-dimensional captured image is provided on the support unit as the displacement measurement unit so as to include the reference subject of the environmental contact unit in an imaging range, and
the displacement measurement unit measures a change in position of the reference subject in the captured image generated by the displacement of the environmental contact unit with respect to the support unit.

9. The detection device according to claim 8, wherein
the environmental contact unit is formed into a hemispherical shell shape, and
an elastic body is included between an end face of the environmental contact unit and an opposing surface provided on the support unit so as to be opposed to the end face.

10. The detection device according to claim 1, wherein
the environmental contact unit and the support unit are connected to each other by a ball joint structure.

11. The detection device according to claim 1, wherein
the environmental contact unit and the support unit are connected to each other by a gimbal structure.

12. The detection device according to claim 1, wherein
the environmental contact unit or the contact surface of the environmental contact unit is formed by using an elastomer.

13. The detection device according to claim 1, wherein
the support unit is provided with
an elastic portion in which elastic bodies of different elastic coefficients are connected in series, and
a linear motion shaft fixed to a connection point of the elastic bodies in the elastic portion and held so as to be movable in an expansion/contraction direction of the elastic bodies,
a moving direction of the linear motion shaft is a direction of a third axis orthogonal to the first axis and the second axis, and
the displacement measurement unit measures a movement amount of the linear motion shaft.

14. The detection device according to claim 1, further comprising:
an arithmetic unit that calculates a force applied to the contact point on a basis of a measurement result of the displacement measurement unit.
